(19) United States
(12) Patent Application Publication
(10) Pub. No.: US 2019/0317993 A1
(43) Pub. Date: Oct. 17, 2019

(54) EFFECTIVE CLASSIFICATION OF TEXT DATA BASED ON A WORD APPEARANCE FREQUENCY

(71) Applicant: FUJITSU LIMITED, Kawasaki-shi (JP)

(72) Inventor: Takamichi Toda, Kawasaki (JP)

(73) Assignee: FUJITSU LIMITED, Kawasaki-shi (JP)

(21) Appl. No.: 16/376,584

(22) Filed: Apr. 5, 2019

(30) Foreign Application Priority Data
Apr. 12, 2018 (JP) 2018-076952

(51) Int. Cl. G06F 17/27

(52) U.S. Cl. CPC G06F 17/2785

(57) ABSTRACT

An apparatus acquires a plurality of text data items each including a question sentence and an answer sentence. The apparatus identifies a first word that exists in each of a plurality of question sentences included in the acquired plurality of text data items where a number of the plurality of question sentences satisfies a predetermined criterion, and identifies, from the plurality of question sentences, a second word that exists in a question sentence not including the first word and that does not exist in a question sentence including the first word. The apparatus classifies the plurality of text data items into a first group of text data items each including a question sentence in which the identified first word exists and a second group of text data items each including a question sentence in which the identified second word exists.

### CROSS-REFERENCE TO RELATED APPLICATION

This application is based upon and claims the benefit of priority of the prior Japanese Patent Application No. 2018-76952, filed on Apr. 12, 2018, the entire contents of which are incorporated herein by reference.

### FIELD

The embodiments disclosed here relates to effective classification of text data based on a word appearance frequency.

### BACKGROUND

A response system is known which automatically responds, in a dialog (chat) form, to a question based on pre-registered FAQ data including a question sentence and an answer sentence.

In one of related techniques, it has been proposed to provide a FAQ generation environment in which a pair of a representative question sentence and a representative answer sentence is evaluated by the number of documents each associated with the representative question sentence that match documents each associated with the representative answer sentence (for example, see Japanese Laid-open Patent Publication No. 2013-50896).

### SUMMARY

According to an aspect of the embodiments, an apparatus acquires a plurality of text data items each including a question sentence and an answer sentence. The apparatus identifies a first word that exists in each of a plurality of question sentences included in the acquired plurality of text data items where a number of the plurality of question sentences satisfies a predetermined criterion, and identifies, from the plurality of question sentences, a second word that exists in a question sentence not including the first word and that does not exist in a question sentence including the first word. The apparatus classifies the plurality of text data items into a first group of text data items each including a question sentence in which the identified first word exists and a second group of text data items each including a question sentence in which the identified second word exists.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a system configuration according to an embodiment;

FIG. 2 is a diagram illustrating an example of a first classification process;

FIG. 3 is a diagram illustrating an example of an extraction process and an example of an analysis process;

FIG. 4 is a diagram illustrating an example of a (first-time) process of identifying a first word;

FIG. 5 is a diagram illustrating an example of a process of identifying a second word;

FIG. 6 is a diagram illustrating an example of a second classification process;

FIG. 7 is a diagram illustrating an example of a (second-time) process of identifying the first word;

FIG. 8 is a diagram illustrating an example of a tree generation process;

FIG. 9 is a diagram illustrating an example of a tree alteration process;

FIG. 10 is a flow chart illustrating an example of a process according to an embodiment;

FIG. 11 is a flow chart illustrating an example of a tree alteration process according to an embodiment;

FIG. 12 is a diagram illustrating an example (a first example) of a response process;

FIG. 13 is a diagram illustrating an example (a second example) of a response process;

FIG. 14 is a diagram illustrating an example (a third example) of a response process;

FIG. 15 is a diagram illustrating an example (a fourth example) of a response process;

FIG. 16 is a diagram illustrating an example (a fifth example) of a response process;

FIG. 17 is a diagram illustrating an example (a sixth example) of a response process;

FIG. 18 is a diagram illustrating an example (a seventh example) of a response process; and

FIG. 19 is a diagram illustrating an example of a hardware configuration of an information processing apparatus.

### DESCRIPTION OF EMBODIMENTS

In a response system using text data (for example, FAQ), when a response to a question is returned, proper text data is identified from pre-registered text data and an answer sentence to the question is output based on the identified text data. However, the greater the number of text data, the longer it takes to identify proper text data, and thus the longer a user may wait.

It is preferable to reduce processing load for identifying proper text data from among a large amount of text data.

Example of overall system configuration according to embodiment

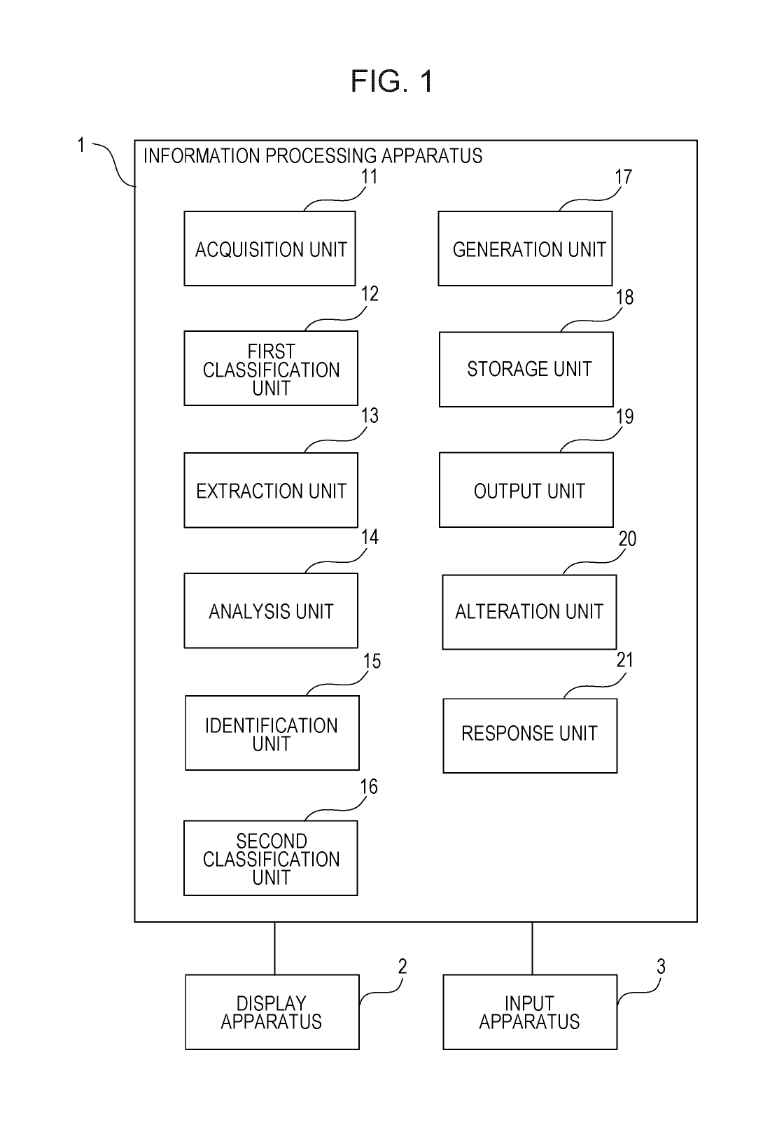

Embodiments are described below with reference to drawings. FIG. 1 is a diagram illustrating an example of a system configuration according to an embodiment. The system according to the embodiment includes an information processing apparatus 1, a display apparatus 2, and an input apparatus 3. The information processing apparatus 1 is an example of a computer.

The information processing apparatus 1 includes an acquisition unit 11, a first classification unit 12, an extraction unit 13, an analysis unit 14, an identification unit 15, a second classification unit 16, a generation unit 17, a storage unit 18, an output unit 19, an alteration unit 20, and a response unit 21.

The acquisition unit 11 acquires a plurality of FAQs each including a question sentence and an answer sentence from an external information processing apparatus or the like. FAQ is an example of text data.

The first classification unit 12 classifies FAQs into a plurality of sets according to a distance of a question sentence included in each FAQ. The distance of a question sentence may be expressed by, for example, a Levenshtein distance. The Levenshtein distance is defined by the minimum number of conversion processes performed to convert a given character string to another character string by processes including insetting, deleting, and replacing of a character, or the like.

For example, in a case where “kitten” is converted to “sitting”, the conversion can be achieved by replacing k with s, repacking e with i, and inserting g at the end. That is, the Levenshtein distance between “kitten” and “sitting” is 3.

The first classification unit 12 may classify FAQs based on a degree of similarity or the like of a question sentence included in each FAQ. The first classification unit 12 may classify FAQs, for example, based on a degree of similarity using N-gram.

The extraction unit 13 extracts a matched part from question sentences in FAQs included in each classified set. The matched part is a character string that occurs in all question sentences in the same set.

The analysis unit 14 performs a morphological analysis on a part remaining after the matched part extracted by the extraction unit 13 is removed from each of the question sentences thereby extracting each word from the remaining part.

The identification unit 15 identifies a first word that exists in the plurality of question sentences included in the acquired FAQs and that satisfies a criterion in terms of the number of question sentences in which the first word exists. The number of question sentences in which a word exists will be also referred to as a word appearance frequency. For example, the first word is given by a word that occurs in a greatest number of question sentences among all question sentences. The identification unit 15 identifies, from the plurality of question sentences, a second word that exists in question sentences in which the first word does not exist and that does not exist in question sentences in which the first word exists.

For example, the identification unit 15 identifies the first word and the second word from the question sentences excluding the matched part.

The second classification unit 16 classifies FAQs such that FAQs including question sentences in which the identified first word is exists and FAQs including question sentences in which the identified second word exists are classified into different groups. In a case where a plurality of text data items are included in some of the classified groups, the second classification unit 16 further classifies each group including the plurality of text data items. The second classification unit 16 is an example of a classification unit.

The generation unit 17 generates a tree such that a node indicating the matched part extracted by the extraction unit 13 is set at a highest level, and a node indicating the first word and a node indicating the second word are set at a level below the highest level and connected to the node at the highest level. Furthermore, answers to questions are put at corresponding nodes at a lowest level of the tree, and the result is stored in the storage unit 18. This tree is used in a response process described later.

The storage unit 18 stores the FAQs acquired by the acquisition unit 11 and the tree generated by the generation unit 17. The output unit 19 displays the tree generated by the generation unit 17 on the display apparatus 2. The output unit 19 may output the tree generated by the generation unit 17 to another apparatus.

In the state in which the tree is displayed by the output unit 19 on the display apparatus 2, when an instruction to alter the tree is issued, the alteration unit 20 alters the tree according to the instruction.

The response unit 21 identifies, using the generated tree, a question sentence corresponding to an accepted question, and displays an answer associated with the question sentence.

For example, when a question is accepted, the response unit 21 searches for a node corresponding to this question from the nodes at the highest level of the tree including a plurality of sets. The response unit 21 displays, as choices, nodes at a level below the node corresponding to the question. In a case where the nodes displayed as the choices are not at the lowest level, if one node is selected from the choices, the response unit 21 further displays, as new choices, nodes at a level below the selected node. In a case where the nodes displayed as the choices are at the lowest level, if one node is selected from the choices, the response unit 21 displays an answer associated with the selected node.

The display apparatus 2 displays the tree generated by the generation unit 17. Furthermore, in the response process, the display apparatus 2 displays a chatbot response screen. When a question from a user is accepted, the display apparatus 2 displays a question for identifying an answer, and also displays the answer to the question. In a case where the display apparatus 2 is a touch panel display, the display apparatus 2 also functions as an input apparatus.

The input apparatus 3 accepts inputting of an instruction to alter a tree from a user. When a chatbot response is performed, the input apparatus 3 accepts inputting of a question and selecting of an item from a user.

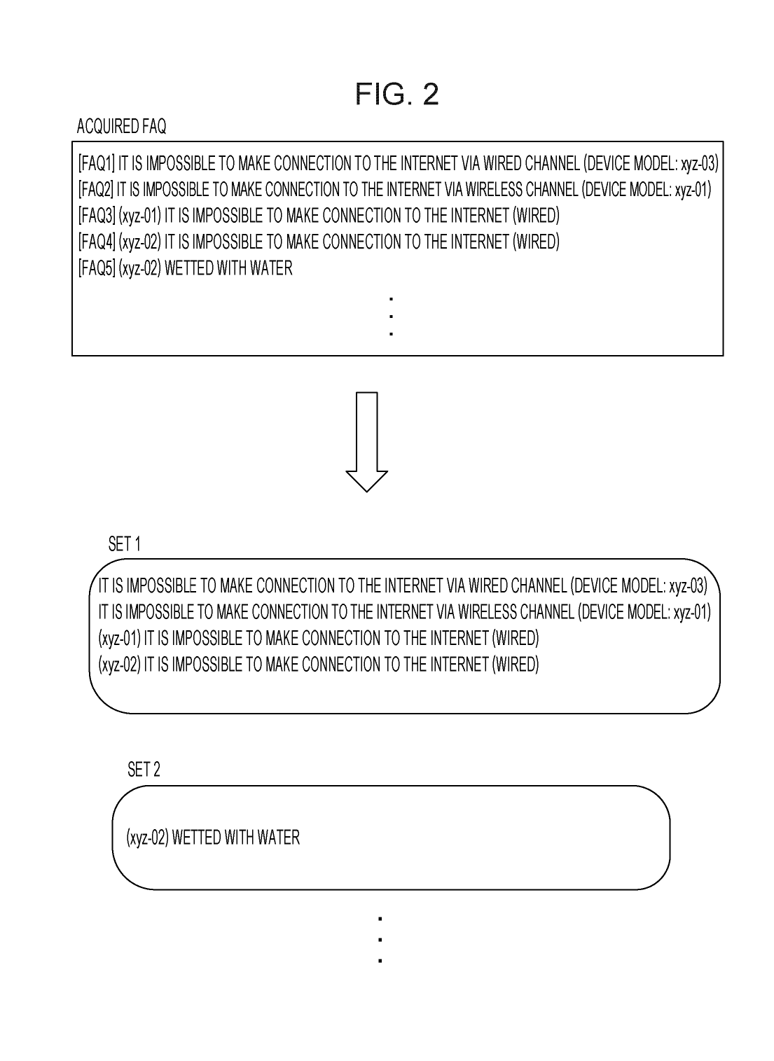

FIG. 2 is a diagram illustrating an example of a first classification process. As illustrated in FIG. 2, the first classification unit 12 classifies a plurality of FAQs acquired by the acquisition unit 11 into a plurality of sets. For example, in a case where Levenshtein distances among a plurality of question sentences are smaller than or equal to a predetermined value, the first classification unit 12 classifies FAQs including these question sentences into the same set.

In the example of the process illustrated in FIG. 2, FAQ1 to FAQ4 are classified into the same set (set 1), while FAQ5 is classified into a set (set 2) different from the set 1. Although no answer sentences are illustrated in FIG. 2, it is assumed that answer sentences are stored in association with question sentences. The process performed on the set 1 is described below by way of example, but similar processes are performed also on other sets.

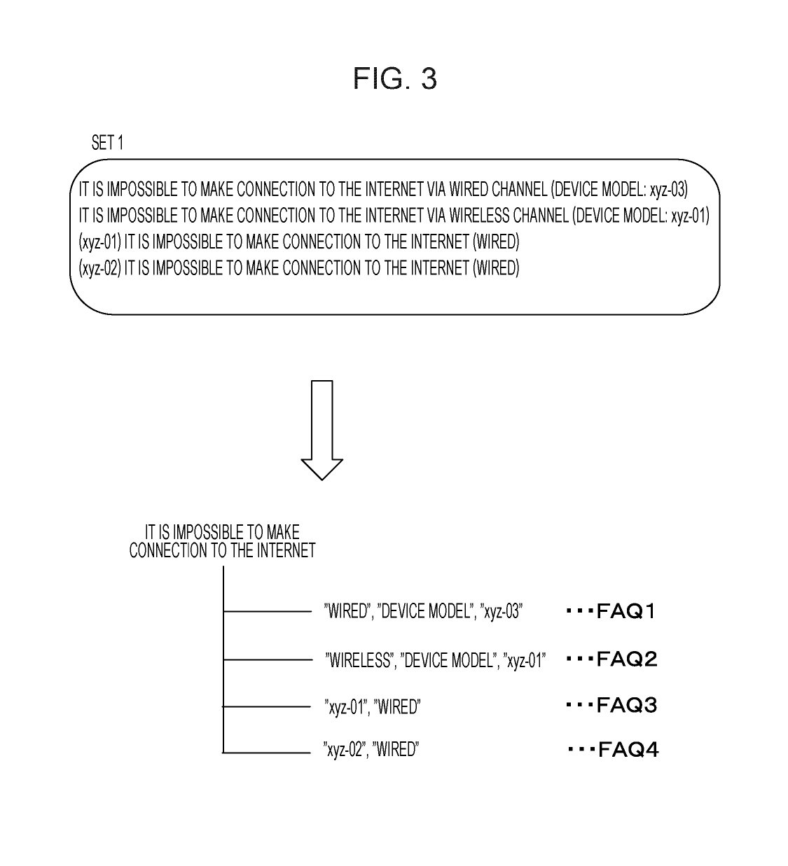

FIG. 3 is a diagram illustrating an example of an extraction process and an example of an analysis process. As illustrated in FIG. 3, each question sentence in the set 1 includes “it is impossible to make connection to the Internet” as a matched part. Thus, the extraction unit 13 extracts “it is impossible to make connection to the Internet” as the matched part.

The analysis unit 14 performs a morphological analysis on each of the question sentences excluding the matched part extracted by the extraction unit 13, thereby extracting each word. In the example illustrated in FIG. 3, the analysis unit 14 extracts words “wired”, “device model”, and “xyz-03” from the question sentence in the FAQ1. Furthermore, the analysis unit 14 extracts words “wireless”, “device model”, and “xyz-01” from the question sentence in the FAQ2. The analysis unit 14 extracts words “xyz-01” and “wired” from the question sentence in the FAQ3. The analysis unit 14 extracts words “xyz-02” and “wired” from the question sentence in the FAQ4.

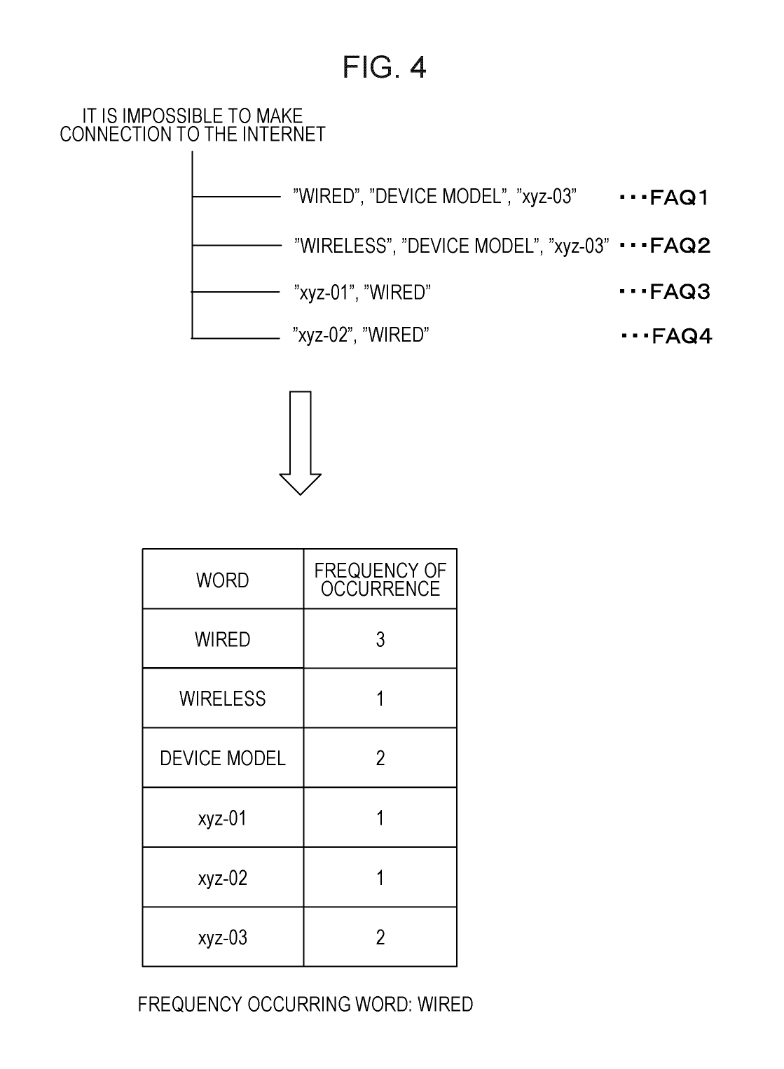

FIG. 4 is a diagram illustrating an example of a (first-time) process of identifying the first word. The identification unit 15 identifies the first word from the plurality of question sentences excluding the matched part. As illustrated in FIG. 4, if “it is impossible to make connection to the Internet”, which is the matched part among the plurality of question sentences, is removed from the respective question sentences, then the resultant remaining parts include words “wired”, “wireless”, “device model”, “xyz-01”, “xyz-02”, and “xyz-03”.

The identification unit 15 identifies the first word from words existing in the parts remaining after the matched part is removed from the plurality of question sentences such that a word (most frequently occurring word) that occurs in a greatest number of question sentences among all question sentences is identified as the first word. In the example illustrated in FIG. 4, a word “wired” is included in FAQ1, FAQ3, and FAQ4, and thus this word occurs in the greatest number of question sentences. Therefore, the identification unit 15 identifies “wired” as the first word.

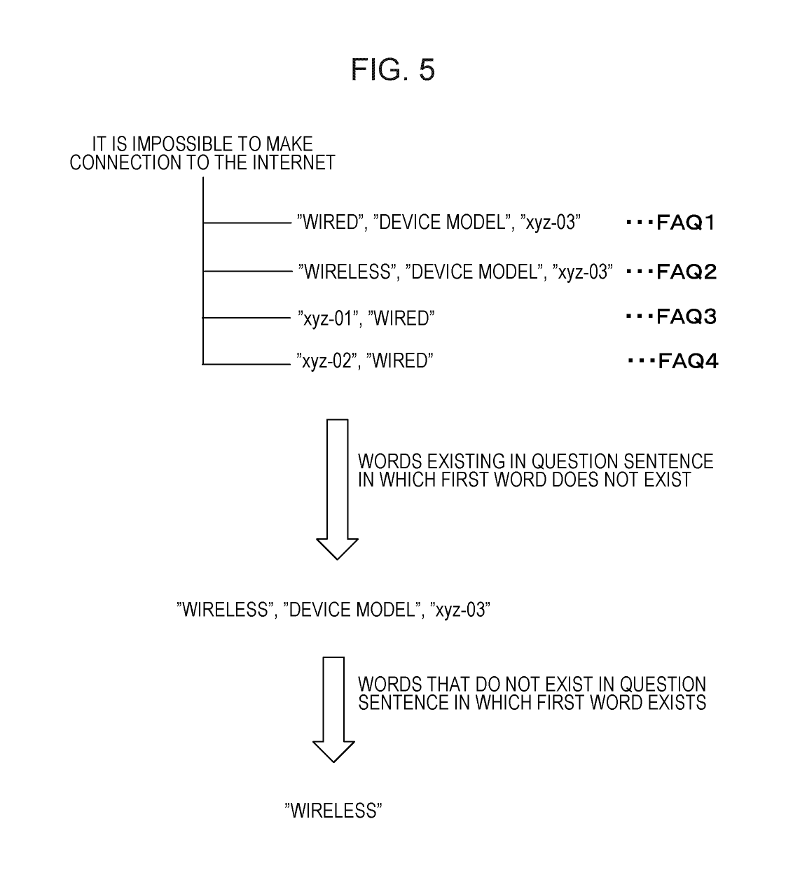

FIG. 5 is a diagram illustrating an example of a process of identifying the second word. The identification unit 15 identifies the second word from the parts remaining after the matched part is removed from the plurality of question sentences such that a word that occurs in question sentences in which the first word does not exist and that does not exist in question sentences in which the first word exists.

In the example illustrated in FIG. 5, in the plurality of question sentences, FAQ2 is a question sentence in which the first word does not exist, while words “wireless”, “device model”, and “xyz-03” exist in FAQ2. Of the words “wireless”, “device model”, and “xyz-03”, “wireless” is a word that does not exist in question sentences (FAQ1, FAQ3, and FAQ4) in which the first word exists. Thus, the identification unit 15 identifies “wireless” as the second word. Note that “device model” and “xyz-03” both exist in FAQ1 in which the first word exists, and thus they are not identified as the second word.

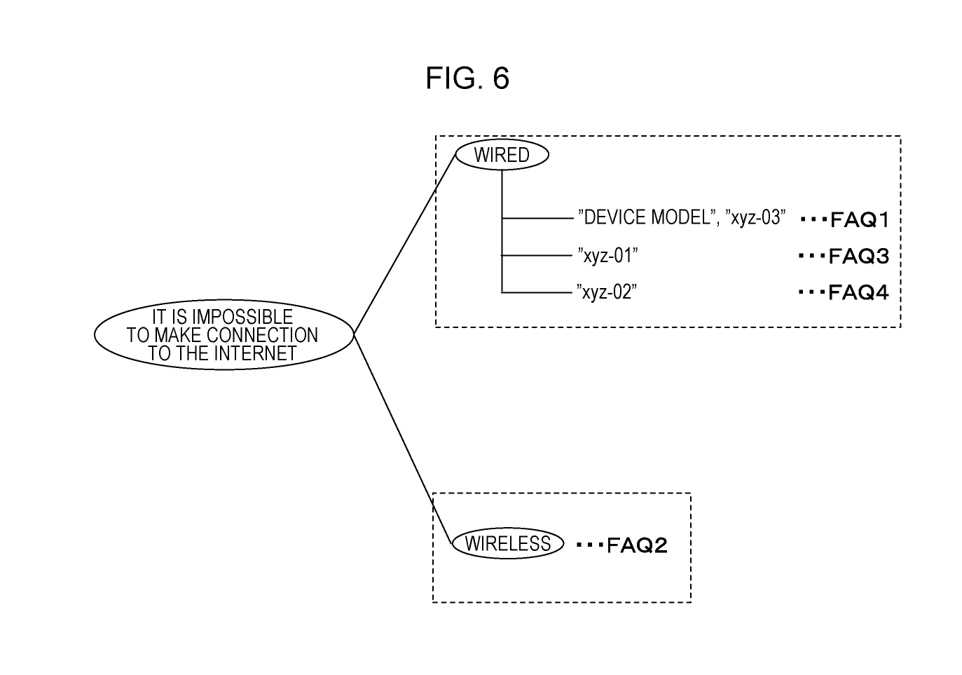

FIG. 6 is a diagram illustrating an example of a second classification process. The second classification unit 16 classifies FAQs such that FAQs including question sentences in which the identified first word exists and FAQs including question sentences in which the identified second word exists are classified into different groups. In the example illustrated in FIG. 6, the second classification unit 16 classifies FAQs such that FAQs (FAQ1, FAQ3, and FAQ4) including question sentences in which “wired” exists and FAQs (FAQ2) including question sentences in which “wireless” exists are classified into different groups.

In the example illustrated in FIG. 6, a group including the first word “wired” includes a plurality of FAQs, and thus there is a possibility that this group can be further classified. Therefore, the information processing apparatus 1 re-executes the identification process by the identification unit 15, the second classification process, and the tree generation process on the group including the first word “wired”. Note that only one FAQ is included in the group including the second word “wireless”, and thus the information processing apparatus 1 does not re-execute the identification process, the second classification process, and the tree generation process on the group including the second word “wireless”.

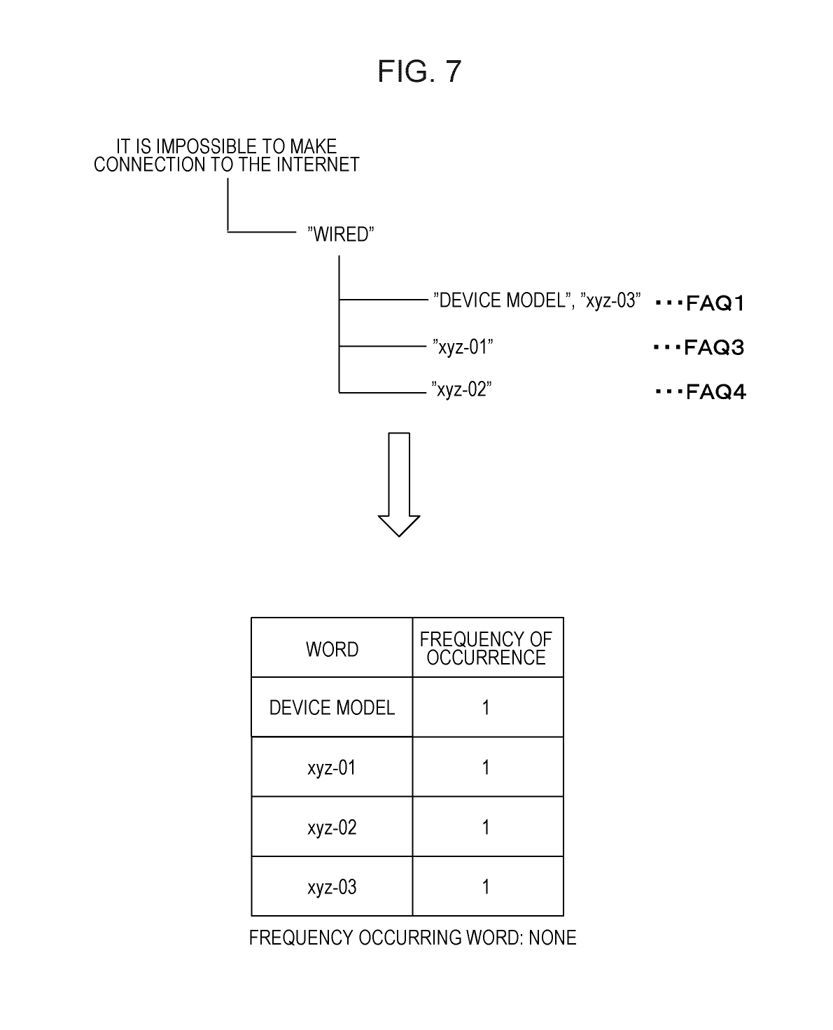

FIG. 7 is a diagram illustrating an example of a (second-time process of identifying the first word. The identification unit 15 identifies the first word from parts remaining after character strings at higher levels of the tree are removed from the plurality of question sentences in the group. In the example illustrated in FIG. 7, the identification unit 15 identifies the first word from parts remaining after “it is impossible to make connection to the Internet” and “wired” are removed from a plurality of question sentences in a group.

As illustrated in FIG. 7, in the parts remaining after the character strings at higher levels in the tree are removed from the plurality of question sentences in the group, words “device model”, “xyz-01”, “xyz-02”, and “xyz-03” each occurs only once. As is the case with this example, when the number of words is 1 for any word that exists in parts remaining after character strings at higher levels of a tree are removed from a plurality of question sentences in a group, the identification unit 15 does not identify the first word.

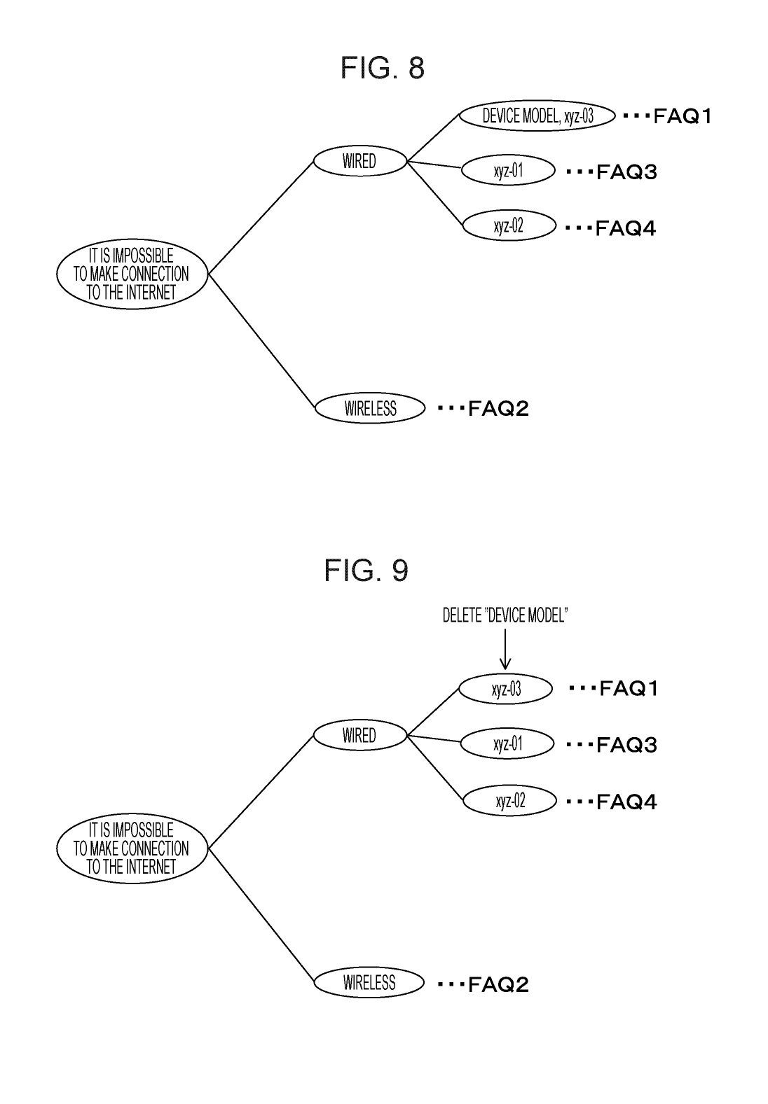

FIG. 8 is a diagram illustrating an example of the tree generation process. The generation unit 17 generates a tree such that the first word and the second word are put at a level below the matched part extracted by the extraction unit 13, and the first word and the second word are connected to the matched part. In the example illustrated in FIG. 8, the generation unit 17 generates a tree such that character strings “wired” and “wireless” are put at a level below a character string “it is impossible to make connection to the Internet” and the character strings “wired” and “wireless” are connected to the character string “it is impossible to make connection to the Internet”.

In a case where the first word is not newly identified as in the case with the example illustrated in FIG. 7, the generation unit 17 sets each word existing in a group including the first word “wired” such that each word is set at a different node for each question sentence including the word. In the example illustrated in FIG. 8, the generation unit 17 sets “device model, xyz-03” included in the question sentence in FAQ1, “xyz-01” included in the question sentence in FAQ3, and “xyz-02” included in the question sentence in FAQ4 such that they are respectively set at different nodes located at a level below “wired”.

The generation unit 17 adds answers to the tree such that answers to questions are connected to nodes at the lowest layer, and the generation unit 17 stores the resultant tree. In the example illustrated in FIG. 8, “device model, xyz-03”, “xyz-01”, “xyz-02”, and “wireless” are at nodes at the lowest level.

By performing the process described above, the generation unit 17 generates a FAQ search tree such that words that occur in a larger number of question sentences are set at higher-level nodes in the tree.

FIG. 9 is a diagram illustrating an example of a tree alteration process. For example, the output unit 19 displays the tree generated by the generation unit 17 on the display apparatus 2. Let it be assumed here that a user has input an alteration instruction by operating the input apparatus 3. In the example illustrated in FIG. 9, it is assumed that a user operates the input apparatus 3 thereby sending, to the information processing apparatus 1, an instruction to delete “device model” from a node where “device model, xyz-03” is put.

The alteration unit 20 alters the tree in accordance with the accepted instruction. In the example illustrated in FIG. 9, “device model” is deleted from “device model, xyz-03” at the specified node.

As described above, when the tree includes an unnatural part, the information processing apparatus 1 may alter the tree in accordance with an instruction given by a user.

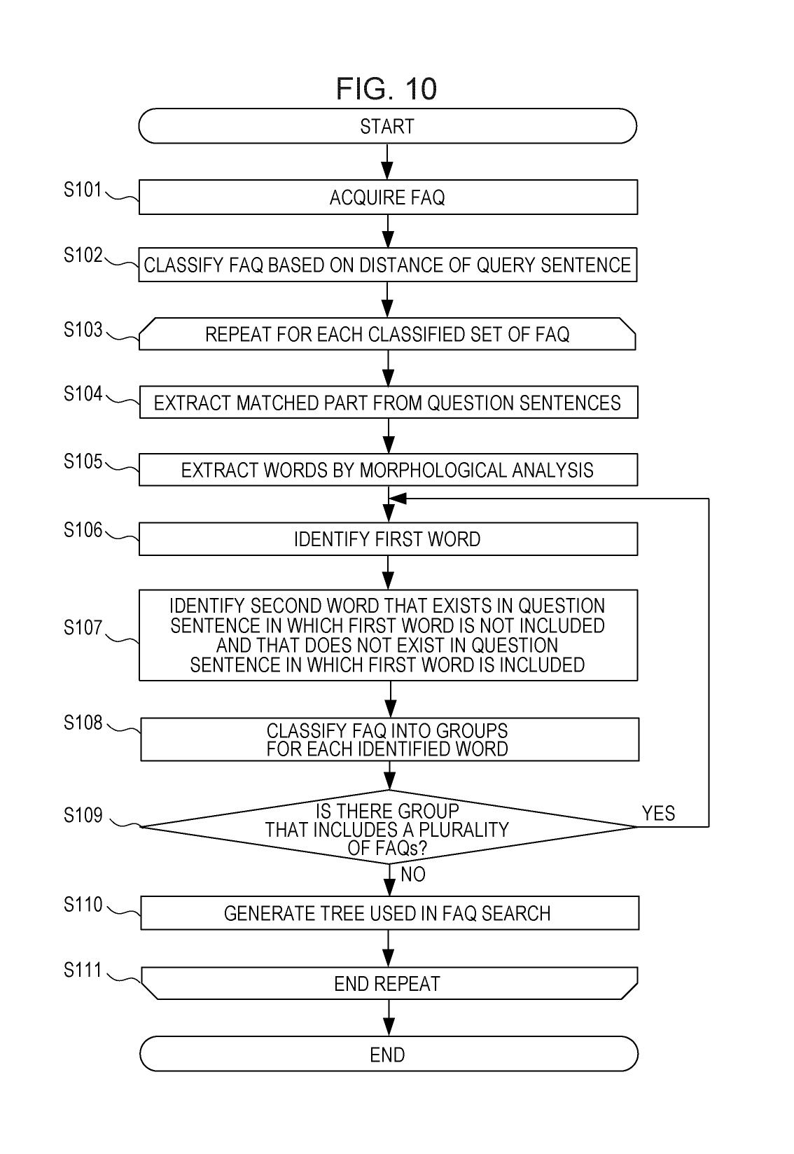

FIG. 10 is a flow chart illustrating an example of a process according to an embodiment. The acquisition unit 11 acquires, from an external information processing apparatus or the like, a plurality of FAQs each including a question sentence and an answer sentence (step S101). The first classification unit 12 classifies FAQs into a plurality of sets according to a distance of a question sentence included in each FAQ (step S102).

The information processing apparatus 1 starts an iteration process on each classified set (step S103). The extraction unit 13 extracts a matched part among question sentences in FAQs included in a set of interest being processed (step S104). The analysis unit 14 performs morphological analysis on a part of each of the question sentences remaining after the matched part extracted by the extraction unit 13 is removed thereby extracting words (step S105).

The identification unit 15 identifies a first word that exists in the plurality of question sentences included in the acquired FAQs and that satisfies a criterion in terms of the number of question sentences in which the first word exists (for example, the first word is given by a word that occurs in a greatest number of question sentences among all question sentences) (step S106). For example, the identification unit 15 identifies the first word from parts remaining after the matched part is removed from the question sentences.

In a case where the number of question sentences in which a certain word exists is one for any of all words, the identification unit 15 does not perform the first-word identification. In this case, the information processing apparatus 1 skips steps S107 and S108 without executing them.

The identification unit 15 identifies, from the plurality of question sentences, a second word that exists in question sentences in which the first word does not exist and that does not exist in question sentences in which the first word exists (step S107). For example, the identification unit 15 identifies the second word from parts remaining after the matched part is removed from the plurality of question sentences.

The second classification unit 16 classifies FAQs such that FAQs including question sentences in which the identified first word exists and FAQs including question sentences in which the identified second word exists are classified into different groups (step S108).

The information processing apparatus 1 determines whether each classified group includes a plurality of FAQs (step S109). In a case where at least one group includes a plurality of FAQs (YES in step S109), the information processing apparatus 1 re-executes the process from step S106 to step S108 on the group. Note that even in a case where a group includes a plurality of FAQs, if the first word is not identified in step S106, then the information processing apparatus 1 does not re-execute the process from step S106 to step S108 on this group.

In a case any of groups does not include a plurality of FAQs (NO in step S109), the process proceeds to step S110.

The generation unit 17 generates a FAQ search tree for a group of interest being processed (step S110). The generation unit 17 adds answers to the tree such that answers to questions are connected to nodes at the lowest level, and the generation unit 17 stores the resultant tree. When the information processing apparatus 1 has completed the process from step S104 to step S110 on all sets, the information processing apparatus 1 ends the iteration process (step S111).

As described above, the information processing apparatus 1 classifies FAQs and generates a tree thereby making it possible to reduce the load imposed on the process of identifying a particular FAQ in a response process. The identification unit 15 identifies a first word that satisfies a criterion in terms of the number of question sentences in which the first word exists (for example, the first word is given by a word that occurs in a greatest number of question sentences among all question sentences), and thus words that occur more frequently are located at higher nodes. This makes it possible for the information processing apparatus 1 to obtain a tree including a smaller number of branches and thus it becomes possible to more easily perform searching in a response process.

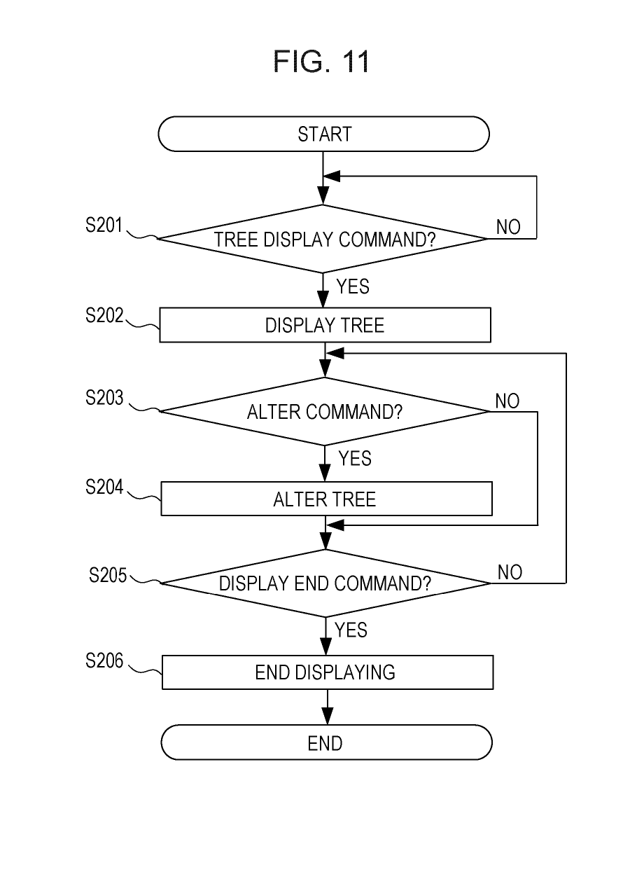

FIG. 11 is a flow chart illustrating an example of a tree alteration process according to an embodiment. Note that the tree alteration process described below is a process performed by the information processing apparatus 1. However, the information processing apparatus 1 may transmit a tree to another information processing apparatus and this information processing apparatus may perform the tree alteration process described below.

The output unit 19 determines whether a tree display instruction is received from a user (step S201). In a case where it is not determined that the tree display instruction is accepted (NO in step S201), the process does not proceed to a next step. In a case where it is determined that the tree display instruction is accepted, the output unit 19 displays a tree on the display apparatus 2 (step S202).

The alteration unit 20 determines whether an alteration instruction (step S203). In a case where an alteration instruction is received (YES in step S203), the alteration unit 20 alters the tree in accordance with the instruction (step S204). After step S201 or in a case where NO is returned in step S203, the output unit 19 determines whether a display end instruction is received (step S205).

In a case where a display end instruction is not received (NO in step S205), the process returns to step S203. In a case where the display end instruction is accepted (YES in step S205), the output unit 19 ends the displaying of the tree on the display apparatus 2 (step S206).

As described above, the information processing apparatus 1 is capable of displaying a tree thereby prompting a user to check the tree. Furthermore, the information processing apparatus 1 is capable of altering the tree in response to an alteration instruction.

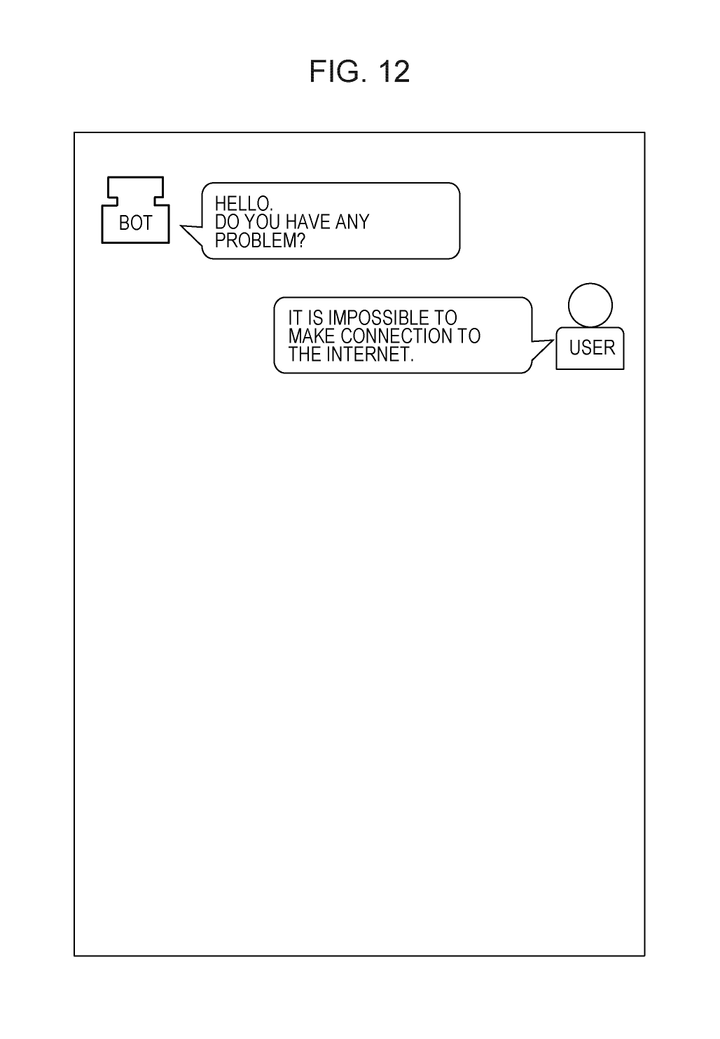

Next, examples of response processes using a FAQ search tree are described below. FIGS. 12 to 18 are diagrams illustrating examples of the response processes. In the examples illustrated in FIGS. 12 to 18, an answer to a question is given via a chatbot such that a conversation is made between “BOT” indicating an answerer and “USER” indicating a questioner (a user). The chatbot is an automatic chat program using an artificial intelligence.

The responses illustrated in FIGS. 12 to 18 are performed by the information processing apparatus 1 and the display apparatus 2. However, responses may be performed by other apparatuses. For example, the information processing apparatus 1 may transmit a tree generated by the information processing apparatus 1 to another information processing apparatus (a second information processing apparatus), and the second information processing apparatus and a display apparatus connected to the second information processing apparatus may perform the responses illustrated in FIGS. 12 to 18. Note that in the examples illustrated in FIGS. 12 to 18, the display apparatus 2 is a touch panel display which accepts a touch operation performed by a user. However, inputting by a user may be performed via the input apparatus 3.

When an operation performed by a user to input an instruction to start a chatbot is received, the response unit 21 displays a predetermined initial message on the display apparatus 2. In the example illustrated in FIG. 12, the response unit 21 displays “Hello. Do you have any problem?” as the predetermined initial message on the display apparatus 2. Let it be assumed here that a user inputs a message “it is impossible to make connection to the Internet”.

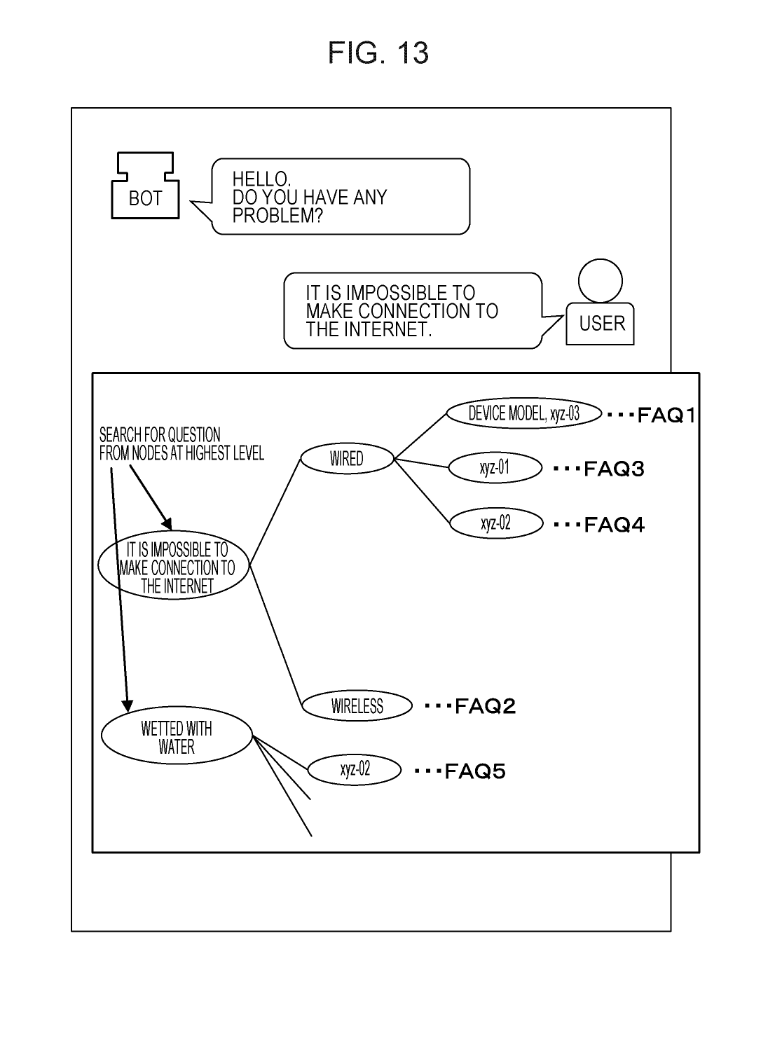

As illustrated in FIG. 13, the response unit 21 searches for a node corresponding to the input question from nodes at the highest level of trees of a plurality of sets generated by the generation unit 17. In the example illustrated in FIG. 13, a node of “it is impossible to make connection to the Internet” is hit as a node corresponding to the input message. In a case where when the response unit 21 searches for a node including the same character string as the input message, if such a node is not found, then response unit 21 may search for a node including a character string similar to the input message.

For example, when the response unit 21 searches for a node including a character string which is the same or similar to an input message, techniques such as Back of word (BoW), Term Frequency-Inverse Document Frequency (TF-IDF), word2vec, or the like may be used.

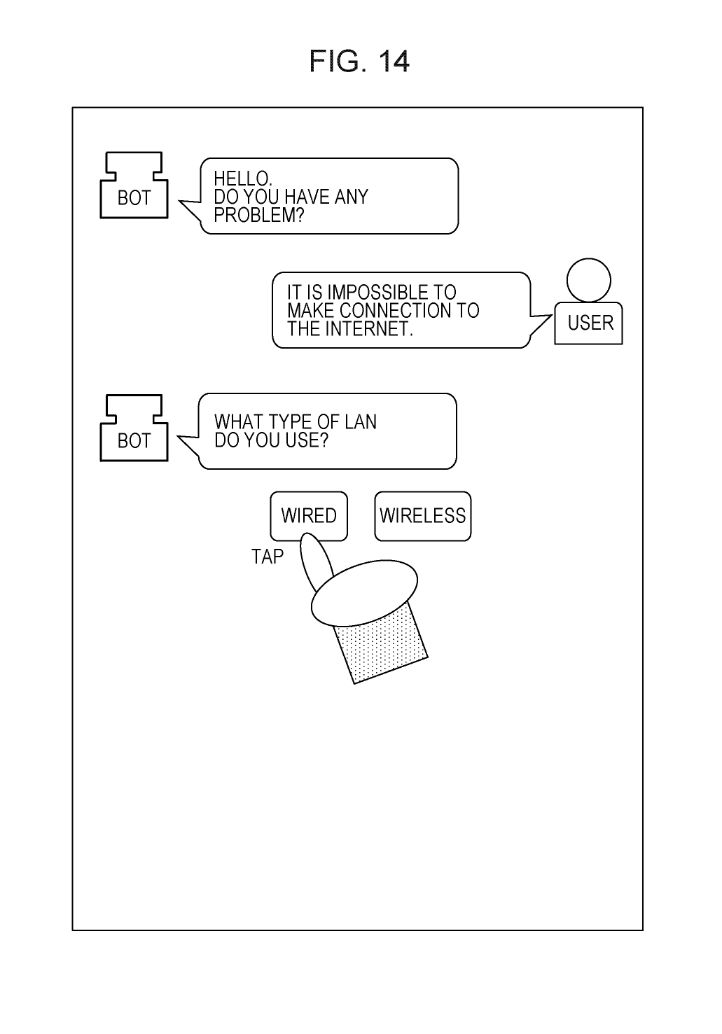

Note that it is assumed that a question sentence is assigned to each of nodes of a tree other than nodes at the lowest level such that the question is used for identifying a lower-level node. Let it be assumed here that “What type of LAN do you use?” is registered in advance as the question sentence for identifying the node below the node of “it is impossible to make connection to the Internet”. Thus, as illustrated in FIG. 14, the response unit 21 displays the question sentence “What type of LAN do you use?”. The response unit 21 further displays, as choices, “wired” and “wireless” at nodes below the node of “it is impossible to make connection to the Internet”. Let it be assumed here that “wired” is selected by a user. In a case where a user selects “wireless” in FIG. 14, then because “wireless” is at a lowest-level node, the response unit 21 displays an answer to FAQ2 associated with “wireless”.

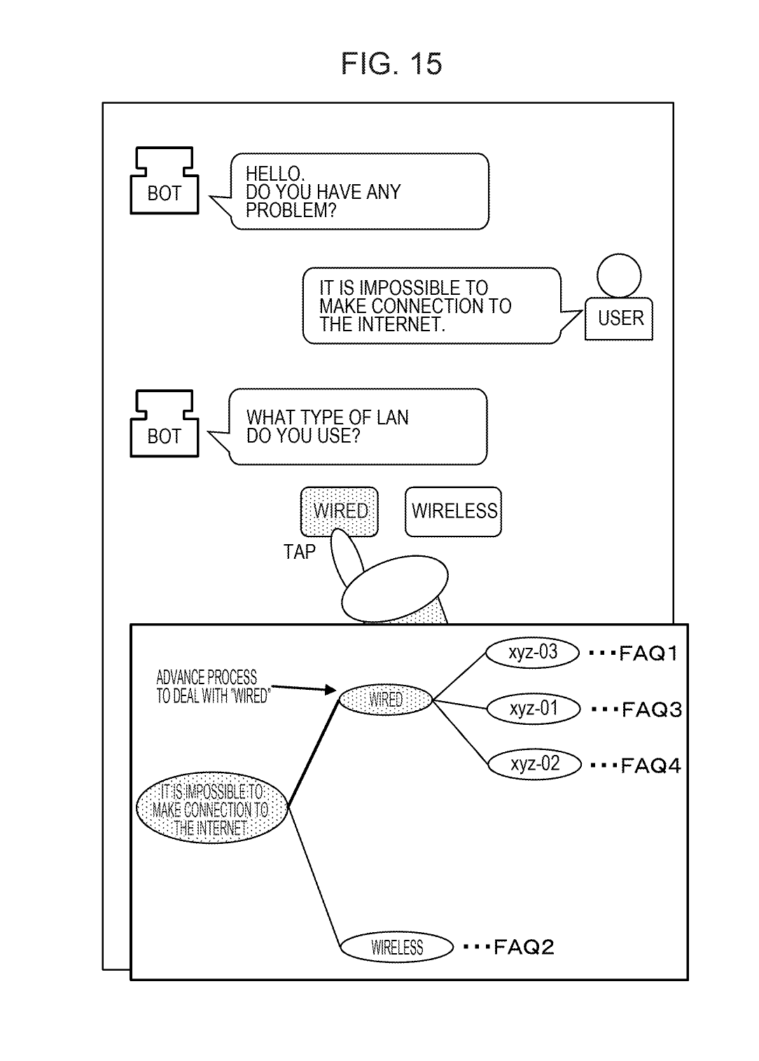

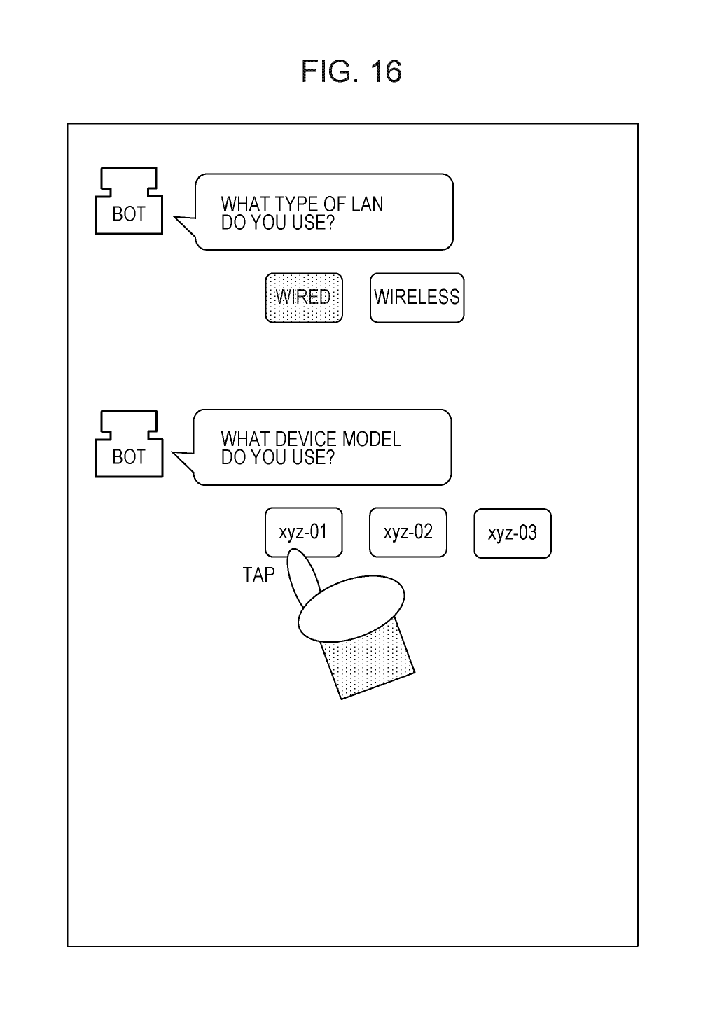

As illustrated in FIG. 15, the response unit 21 selects “wired” on the tree as a node to be processed. The node of “wired” is not a lowest-level node, but there are nodes at a level further lower than the level of the node of “wired”. Therefore, the response unit 21 displays “What device model do you use?” registered in advance as a question sentence for identifying a node below “wired” as illustrated in FIG. 16. The response unit 21 further displays, as choices, “xyz-01”, “xyz-02”, and “xyz-03” at nodes below “wired”. Let it be assumed here that a user selects “xyz-01”.

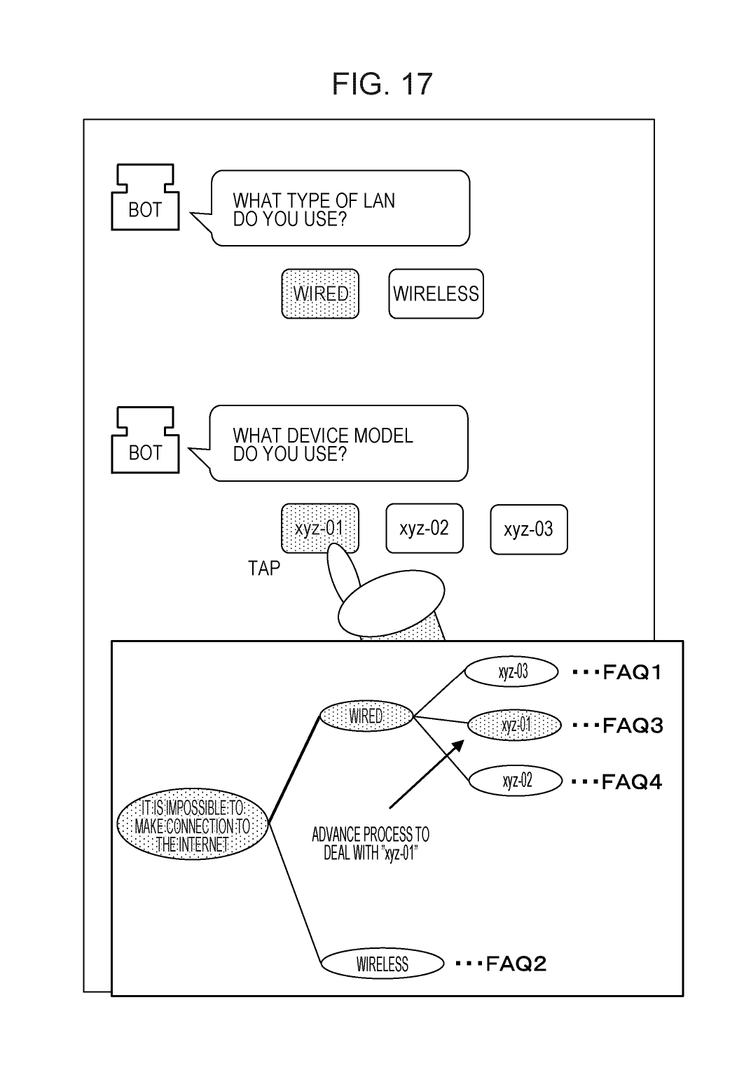

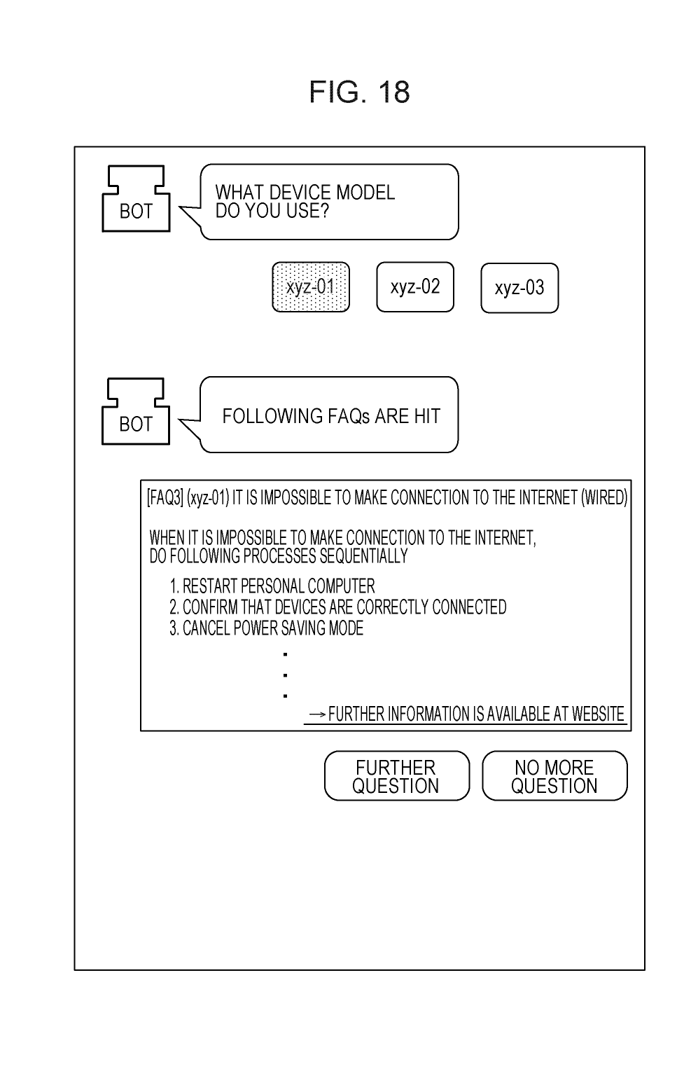

In response, as illustrated in FIG. 17, the response unit 21 selects “xyz-01” on the tree as a node to be processed. Note that “xyz-01” is a lowest-level node of the tree. Therefore, the response unit 21 displays, as an answer sentence associated with the lowest-level node of FAQ (FAQ3) together with a predetermined message as illustrated in FIG. 18. As the predetermined message, for example, the response unit 21 displays “Following FAQs are hit”.

As described above, the response unit 21 searches a tree for a question sentence corresponding to a question input by a user and displays an answer corresponding to an identified question sentence. Using a tree in searching for a question sentence makes it possible to reduce a processing load compared with a case where all question sentences of FAQs are sequentially checked, and thus it becomes possible to quickly display an answer.

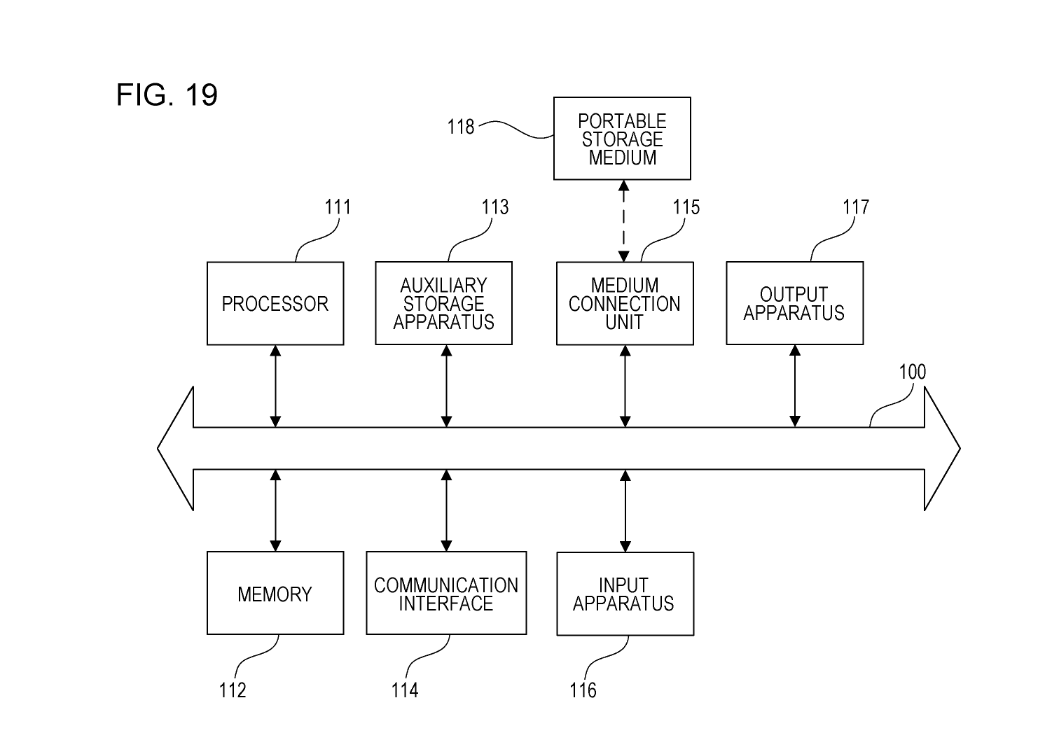

Next, an example of a hardware configuration of the information processing apparatus 1 is described below. FIG. 19 is a diagram illustrating an example of a hardware configuration of the information processing apparatus 1. As in the example illustrated in FIG. 19, in the information processing apparatus 1, a processor 111, a memory 112, an auxiliary storage apparatus 113, a communication interface 114, a medium connection unit 115, an input apparatus 116, and an output apparatus 117, are connected to a bus 100.

The processor 111 executes a program loaded in the memory 112. The program to be executed may a classification program that is executed in a process according to an embodiment.

The memory 112 is, for example, a Random Access Memory (RAM). The auxiliary storage apparatus 113 is a storage apparatus for storing a various kinds of information. For example, a hard disk drive, a semiconductor memory, or the like may be used as the auxiliary storage apparatus 113. The classification program for use in the process according to the embodiment may be stored in the auxiliary storage apparatus 113.

The communication interface 114 is connected to a communication network such as a Local Area Network (LAN), a Wide Area Network (WAN), or the like and performs a data conversion or the like in communication.

The medium connection unit 115 is an interface to which the portable storage medium 118 is connectable. The portable storage medium 118 may be, for example, an optical disk (such as a Compact Disc (CD), a Digital Versatile Disc (DVD), or the like), a semiconductor memory, or the like. The portable storage medium 118 may be used to store the classification program for use in the process according to the embodiment.

The input apparatus 116 may be, for example, a keyboard, a pointing device, or the like, and is used to accept inputting of an instruction, information, or the like from a user. The input apparatus 116 illustrated in FIG. 19 may be used as the input apparatus 3 illustrated in FIG. 1.

The output apparatus 117 may be, for example, a display apparatus, a printer, a speaker, or the like, and outputs a query, an instruction, a result of the process, or the like to a user. The output apparatus 117 illustrated in FIG. 19 may be used as the display apparatus 2 illustrated in FIG. 1.

The storage unit 18 illustrated in FIG. 1 may be realized by the memory 112, the auxiliary storage apparatus 113, the portable storage medium 118, or the like. The acquisition unit 11, the first classification unit 12, the extraction unit 13, the analysis unit 14, the identification unit 15, the second classification unit 16, the generation unit 17, the output unit 19, the alteration unit 20, and the response unit 21, which are illustrated in FIG. 2, may be realized by executing, by the processor 111, the classification program loaded in the memory 112.

The memory 112, the auxiliary storage apparatus 113, and the portable storage medium 118 are each a computer-readable non-transitory tangible storage medium, and are not a transitory medium such as a signal carrier wave.

Other Issues

Note that the embodiments of the present disclosure are not limited to examples described above, but many modifications, additions, removals are possible without departing the scope of the present embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process comprising:
acquiring a plurality of text data items each including a question sentence and an answer sentence;
identifying a first word that exists in each of a plurality of question sentences included in the acquired plurality of text data items, a number of the plurality of question sentences satisfying a predetermined criterion;
identifying, from the plurality of question sentences, a second word that exists in a question sentence not including the first word and that does not exist in a question sentence including the first word; and
performing a classification process on the plurality of text data items by classifying the plurality of text data items into a first group of text data items each including a question sentence in which the identified first word exists and a second group of text data items each including a question sentence in which the identified second word exists.

2. The non-transitory, computer-readable recording medium of claim 1, the process further comprising:
extracting, from the plurality of question sentences, a matched part that is included in all of the plurality of question sentences;
identifying the first word and the second word from the plurality of question sentences each excluding the matched part;
generating a tree in which:
a first node indicating the matched part is set at a highest level, and
second nodes indicating the first word and the second word are set at a level below the highest level and connected to the first node at the highest level.

3. The non-transitory, computer-readable recording medium of claim 1, the process further comprising identifying, as the first word, a word that exists in the plurality of question sentences and that occurs in a greatest number of question sentences among the plurality of question sentences.

4. The non-transitory, computer-readable recording medium of claim 1, the process further comprising, in a case where one of the first group and the second group includes multiple text data items, performing the classification process on the multiple text data items.

5. The non-transitory, computer-readable recording medium of claim 2, the process further comprising:
displaying the generated tree on a display apparatus; and
altering the tree in accordance with an alteration instruction.

6. The non-transitory, computer-readable recording medium of claim 2, the process further comprising, when a question is accepted, performing a display process including:
searching the tree for a third node corresponding to the question in a direction from the first node at the highest level of the tree towards nodes at lower levels;
displaying, as choices, choice nodes at a level below the third node so that one of the choice nodes is selected as a selected node;
when the choice nodes displayed as the choices are not at a lowest level of the tree, further displaying, as choices, next choice nodes at a level below the selected node; and
when the choice nodes displayed as choices are at the lowest level of the tree, displaying an answer associated with the selected node.

7. A classification method comprising:
acquiring a plurality of text data items each including a question sentence and an answer sentence;
identifying a first word that exists in each of a plurality of question sentences included in the acquired plurality of text data items, a number of the plurality of question sentences satisfying a predetermined criterion;
identifying, from the plurality of question sentences, a second word that exists in a question sentence not including the first word and that does not exist in a question sentence including the first word; and
classifying the plurality of text data items into a first group of text data items each including a question sentence in which the identified first word exists and a second group of text data items each including a question sentence in which the identified second word exists.

8. A classification apparatus comprising:
a memory; and
a processor coupled to the memory and configured to:
acquire a plurality of text data items each including a question sentence and an answer sentence,
identify a first word that exists in each of a plurality of question sentences included in the acquired plurality of text data items, a number of the plurality of question sentences satisfying a predetermined criterion,
identify, from the plurality of question sentences, a second word that exists in a question sentence not including the first word and that does not exist in a question sentence including the first word, and
classify the plurality of text data items into a first group of text data items each including a question sentence in which the identified first word exists and a second group of text data items each including a question sentence in which the identified second word exists.
